(19) United States
(12) Patent Application Publication
(10) Pub. No.: US 2023/0286585 A1
(43) Pub. Date: Sep. 14, 2023

(54) VEHICLE FRAME APPARATUS FOR ACCOMMODATING WHEELCHAIR RAMP

(71) Applicant: Pindz Mooker-Mahadev, Richmond (CA)

(72) Inventor: Pindz Mooker-Mahadev, Richmond (CA)

(21) Appl. No.: 17/653,955

(22) Filed: Mar. 8, 2022

(51) Int. Cl. B62D 21/11; B60G 7/00

(52) U.S. Cl. CPC B62D 21/11; B60G 7/001

(57) ABSTRACT

A vehicle frame apparatus that is configured to be operably secured to a vehicle so as to provide modifications to the vehicle in order to facilitate the vehicle accepting accessories such as but not limited to a wheelchair tub. The present invention includes a hanger assembly wherein the hanger assembly includes an upper portion and a lower portion. The hanger assembly is operably to provide a lower mounting position for the axle on vehicles having independent wheel suspension. The present invention further includes an upper spring mount and a lower spring mount. The lower spring mount provides a spring retention member configured to assist in position maintenance of the lower end of a spring. An upper shock mount is included so as to position the shock in a proper position. A hub spacer is also included so as to move the hub outward from the axle.

### FIELD OF THE INVENTION

The present invention relates generally to vehicle frames, more specifically but not by way of limitation, a vehicle frame apparatus that is configured to provide access for wheelchair tubs and other similar elements wherein the vehicle includes independent suspension.

### BACKGROUND

Vehicle frames are well known in the art and are also referred to as the chassis. The frame supports not only the body of the vehicle but further provides the necessary structure to support the motor and other components such as but not limited to the suspension. Depending upon the type of vehicle and the design purpose thereof, chassis can employ different types of suspension components. One common type of suspension system is an independent suspension system. This provides an improved ride as each wheel is controlled by its own suspension components and as such is allowed to react to the condition of the road under the wheel without transferring any motion to other wheels.

While independent suspension components provide benefits, there are issues created by the design that can make certain vehicle modifications difficult or impossible. By way of example, for some types of vehicles such as mini vans the independent suspension can inhibit accessories such as wheel chair ramps and tubs. Physically challenged drivers must have their vehicles modified in order to accommodate their wheel chair. These modifications require access elements for the wheelchair such as but not limited to a ramp and further require other elements to ensure space to store the wheelchair once placed in the vehicle. One issue arises with certain types of mini vans having independent suspension that results in an inability to add these wheelchair components with the stock chassis.

Accordingly, there is a need for a chassis modification that is configured to facilitate the ability to accommodate wheelchair access and storage elements wherein the present invention includes a frame modification to a vehicle type having independent suspension.

### SUMMARY OF THE INVENTION

It is the object of the present invention to provide a vehicle frame apparatus that includes elements configured to facilitate mounting of wheelchair components to the vehicle wherein the present invention includes a modified axle and hanger.

Another object of the present invention is to provide a modified vehicle frame having independent suspension that enables the vehicle to be outfitted for wheelchair elements wherein the present invention further includes a spacer that is placed between the axle and hub.

A further object of the present invention is to provide a vehicle frame apparatus that includes elements configured to facilitate mounting of wheelchair components to the vehicle that further includes a bottom spring pocket modification.

Still another object of the present invention is to provide a modified vehicle frame having independent suspension that enables the vehicle to be outfitted for wheelchair elements wherein the present invention further includes a modified hub mount.

An additional object of the present invention is to provide a vehicle frame apparatus that includes elements configured to facilitate mounting of wheelchair components to the vehicle that further includes a spring retention member.

Yet a further object of the present invention is to provide a modified vehicle frame having independent suspension that enables the vehicle to be outfitted for wheelchair elements wherein the present invention further includes a modified shock bracket.

Another object of the present invention is to a provide a vehicle frame apparatus that includes elements configured to facilitate mounting of wheelchair components to the vehicle wherein a mounting bracket for a top of a shock is present.

An alternate object of the present invention is to provide a modified vehicle frame having independent suspension that enables the vehicle to be outfitted for wheelchair elements wherein the present invention that further includes a c-shaped member as part of the hanger assembly.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the axle of the present invention; and

FIG. 2 is side view of the hanger assembly of the present invention; and

FIG. 3 is a side view of the spring retention member; and

FIG. 4 is a rear perspective view of the hanger assembly of the present invention; and

FIG. 5 is a bottom view of the spring mount of the present invention; and

FIG. 6 is a detailed view of the hanger assembly secured to the frame; and

FIG. 7 is a detailed view of the axle hanger of the present invention; and

FIG. 8 is a top view of the bottom of the spring mount assembly; and

FIG. 9 is a detailed view of a shock mount of the present invention; and

FIG. 10 is a detailed rear view of the hanger assembly of the present invention; and

FIG. 11 is a top view of a spacer of the present invention; and

FIG. 12 is a perspective view of the hub of the present invention; and

FIG. 13 is an end view of the axle and hub brake assembly of the present invention.

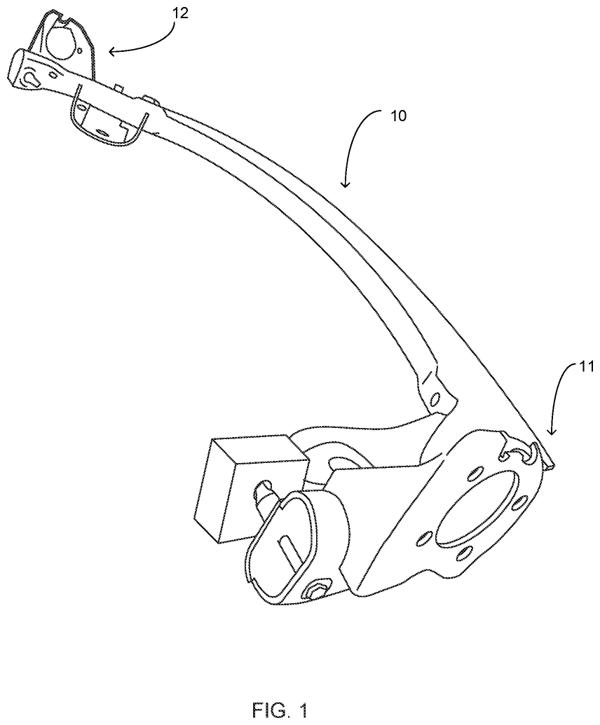

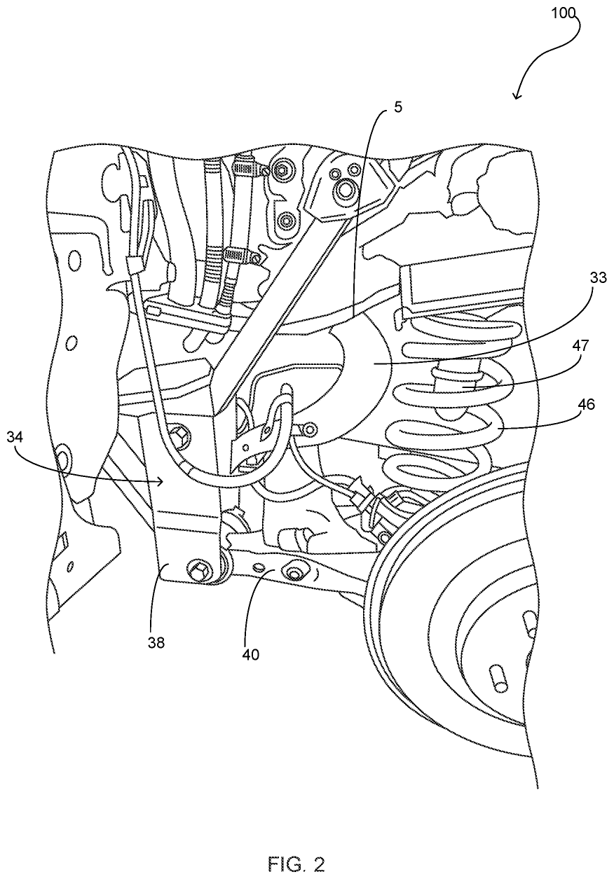

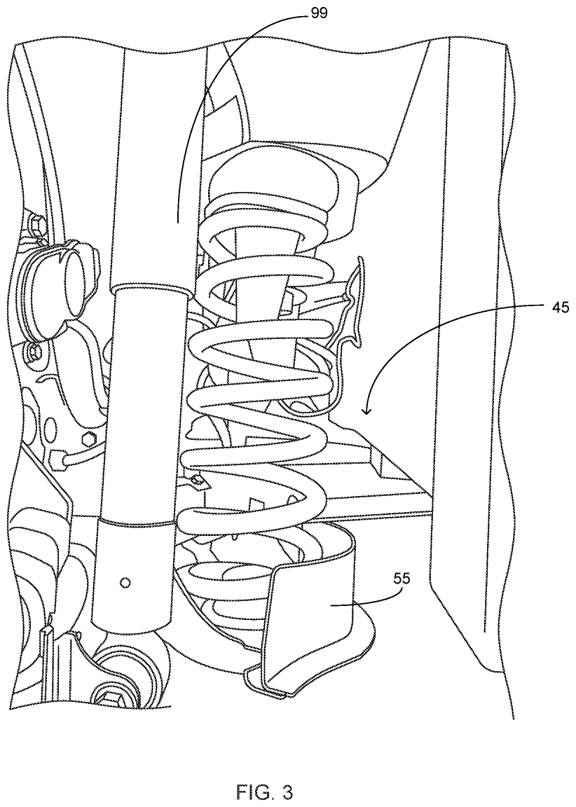

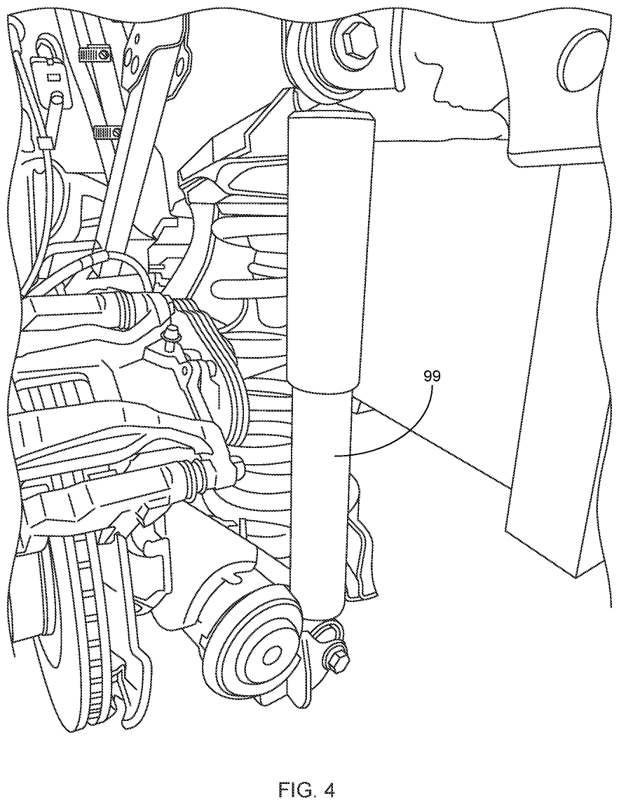

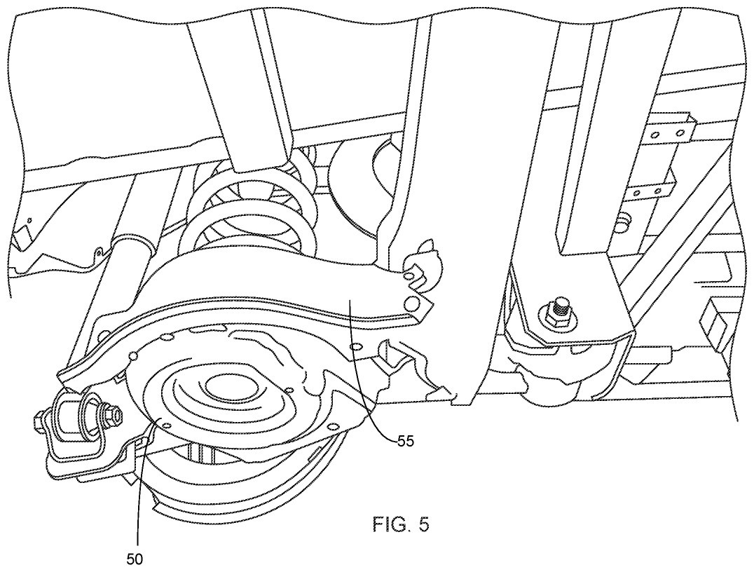

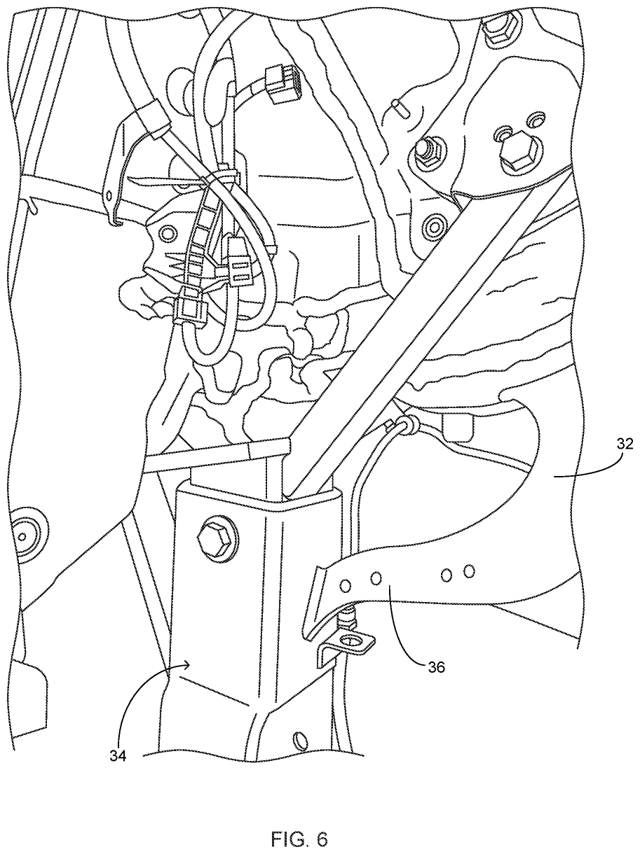

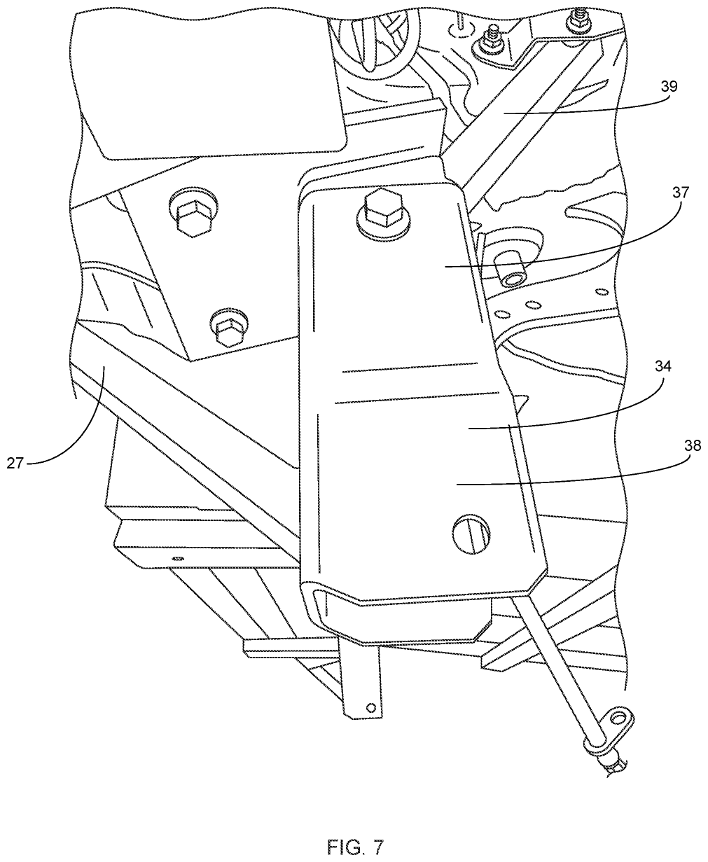

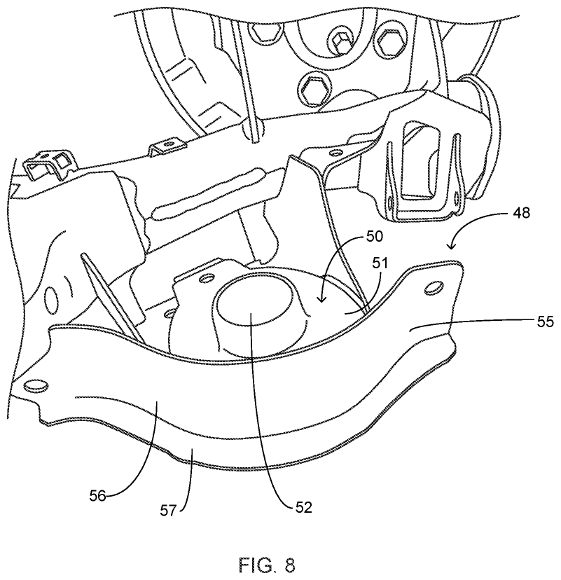

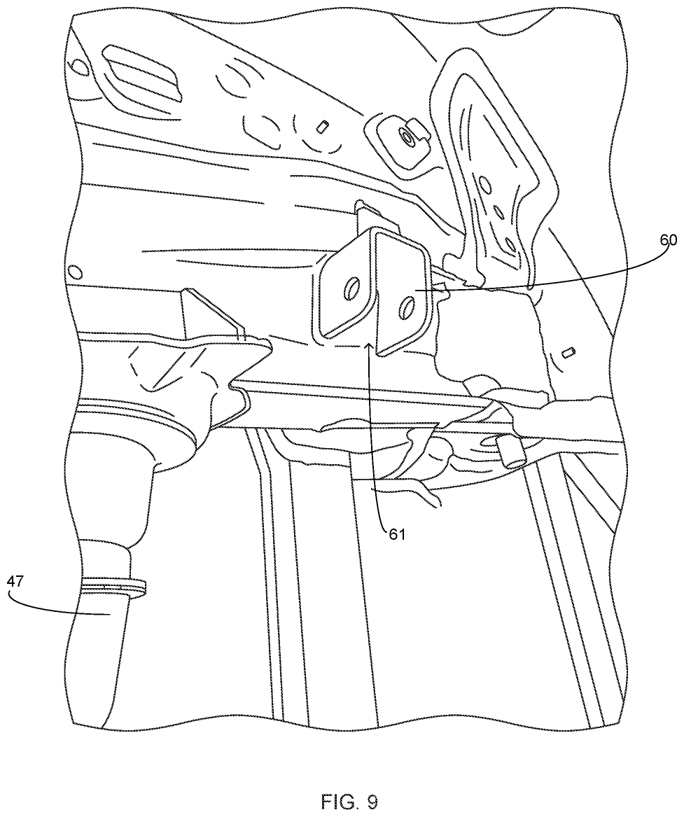

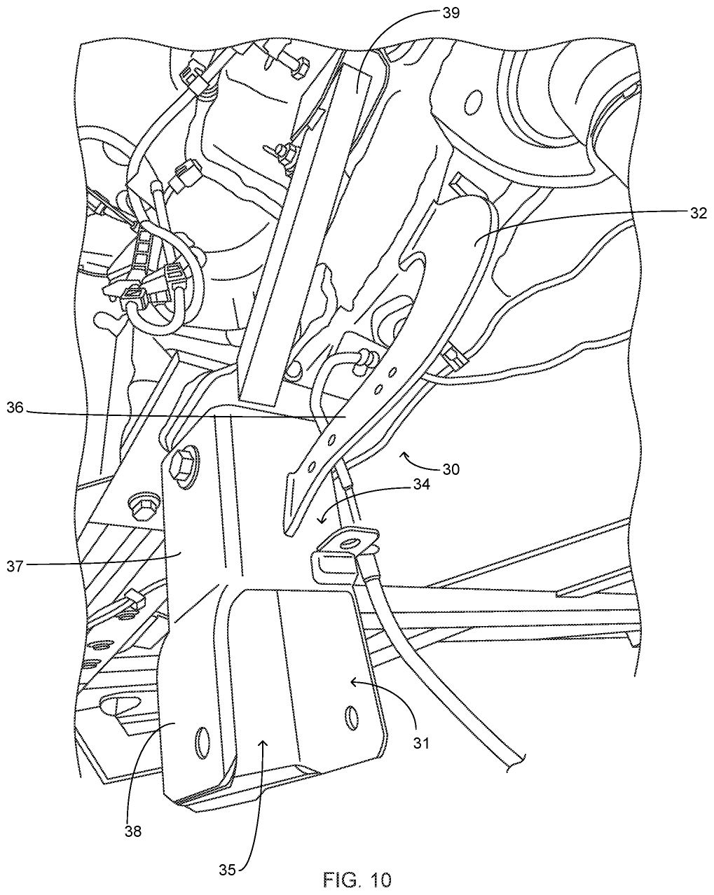

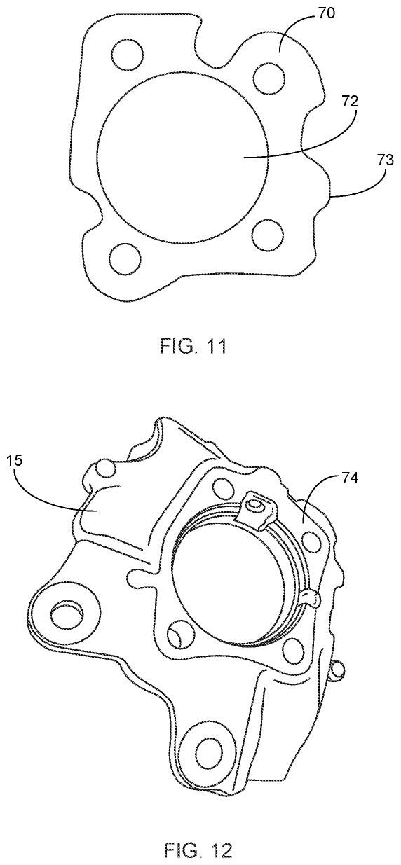

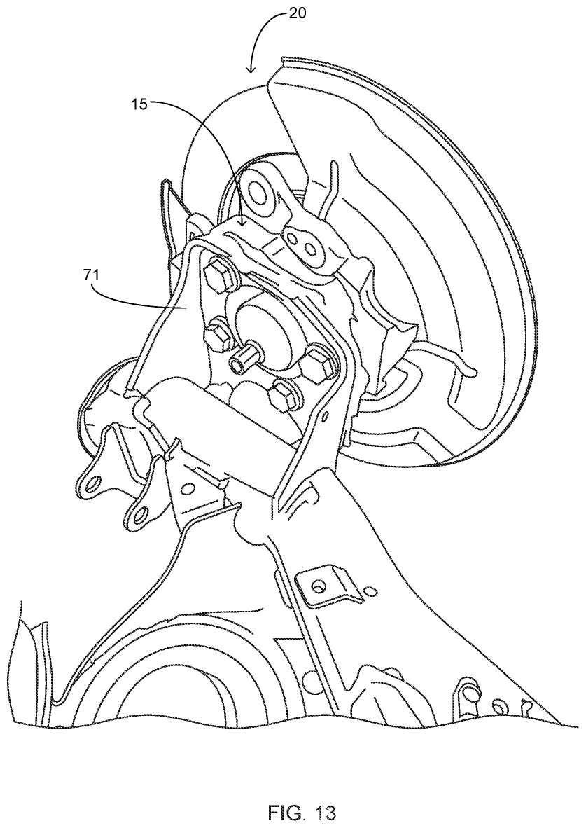

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle frame apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the vehicle frame apparatus 100 is manufactured from metal and the components thereof are secured utilizing techniques that include but are not limited to mechanical fasteners and welding. The vehicle frame apparatus 100 includes an axle 10 wherein the axle 10 includes a first end 11 and a second end 12. The ends of the axle are configure to have a hub 15 secured thereto wherein the hub 15 has operably coupled thereto the brake assembly 20. The brake assembly 20 is a conventional disc brake assembly and it should be understood within the scope of the present invention that a brake assembly 20 is operably coupled to each end of the axle. It should be understood within the scope of the present invention that the size and shape of the axle 10 could vary based upon the vehicle in which the vehicle frame apparatus 100 is being mounted. The vehicle frame apparatus 100 embodied herein is for a specific model of a minivan but it should be understood that the vehicle frame apparatus 100 could be adapted to operably couple into alternate styles of vehicles.

The vehicle frame apparatus 100 includes a hanger assembly 30 wherein the hanger assembly 30 provides the operably coupling of the axle 10 to the frame of the vehicle and further accommodates the independent suspension components. The hanger assembly 30 includes an upper support member 32 and a lower support member 34. The upper support member 32 is planar in manner having a curved upper section 33 that is shaped to secure to frame portion 5. The curved upper section 33 is contiguous with lower section 36 wherein the lower section 36 is operably coupled with the lower support member 34. The lower support member 34 includes upper portion 37 and lower portion 38. The lower support member 34 provides a lower mounting point for the axle 10 in order to allow the vehicle to accommodate further modifications for wheelchairs and components related thereto. The upper portion 37 is welded to the frame and further includes a support arm 39 operably coupled thereto wherein the support arm 39 also terminates into the frame and is operably coupled thereto. The lower portion 38 includes opening 31 having void 35 wherein the void 35 is configured to have secured there an end of suspension arm member 40. The lower support member 34 further includes rear support arm member 27 wherein rear support arm member 27 is operably coupled to the rear wall of the lower support member 34 and the frame providing the necessary structural support and proper position. The rear arm support member 27 is angular in orientation with the lower support member 34 and is manufactured from square metal tubing. It should be understood within the scope of the present invention that the vehicle frame apparatus 100 includes two lower support members 34 equally constructed and opposedly located on the chassis of the vehicle on which the vehicle frame apparatus 100 has been installed.

The suspension arm member 40 has operably coupled thereto distal to the lower support member 34 a spring mount assembly 45. The spring mount assembly includes a spring 46, upper spring mount member 47 and lower spring mount member 48. The spring mount assembly 45 is adjacent to shock absorber 50 and the two combine in an arrangement to provide independent wheel suspension. The spring 46 is a conventional metal spring having sufficient force to execute the desired application. The upper spring mount 47 is conical in shape and extends downward from a frame portion. The upper spring mount 47 is shaped so as to be insertably coupled with the upper end of the spring 46 so as to retain spring 46 in a desired position at the upper end thereof. It should be understood within the scope of the present invention that the upper spring mount 47 could be provided in alternate shapes and sizes and still achieve the desired objective.

The lower spring mount member includes a first portion 50. The first portion 50 is annular in shape having an upper surface 51. The upper surface 51 has formed thereon a spring engagement member 52. The spring engagement member 52 extends upward from the upper surface 51 of the first portion 50. The spring engagement member 52 protrudes into the lower end of the spring 46 so as to provide positional securing thereof. Adjacent to the first portion 50 is the spring retention member 55. The spring retention member 55 is a modified c-shaped structure having an upper wall 56 and lower wall 57. The upper wall 56 is positioned adjacent to the first portion 50 and is formed in order to ensure positional stability and security of the spring 46. The lower wall 57 is contiguous with the upper wall 56 and extends outward therefrom away from first portion 50.

The vehicle frame apparatus 100 further includes an upper shock mounting bracket 60. The upper shock mounting bracket 60 is square u-shaped and is configured with a bottom opening 61 so as to operably coupled to a top end of a shock 99. The upper shock mounting bracket 60 is secured to a portion of a wheel well and is positioned so as to move the shock 99 so that the vehicle frame apparatus 100 can permit the vehicle to which the vehicle frame apparatus 100 is mounted an ability to accommodate elements such as but not limited to wheelchair tubs. In order to further accommodate the ability for the aforementioned element to be placed in a vehicle in which the vehicle frame apparatus 100 is secured, the vehicle frame apparatus 100 includes a hub spacer 70. The hub spacer 70 is secured to hub mount 71 wherein the hub mount 71 is formed on the end of axle 10. The hub spacer 70 moves the hub 15 outwards from the end of the axle 10. The hub spacer 70 is manufactured from metal and includes a center aperture 72. The peripheral edge 73 of the hub spacer 70 is shaped so as to mateably align with the hub surface 74 so as to accommodate fastening thereto so as to be between the hub mount 71 and the hub 15. It should be understood within the present invention that the hub spacer 70 could be provided in alternate thicknesses so as to facilitate the outward mounting of the hub 15 as needed to ensure proper mounting of the vehicle frame apparatus 100.

The vehicle frame apparatus 100 provides a positioning of the axle 10 wherein the axle position is lower than that of the position of the axle when the vehicle frame apparatus 100 is not operably coupled to a vehicle. The vehicle frame apparatus 100 is configured to accommodate independent suspension and provides location of components thereof in a required position in order for a vehicle to which the vehicle frame apparatus 100 has been mounted to accommodate elements such as but not limited to a wheelchair tub.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A vehicle frame apparatus that is mounted to a vehicle so as to facilitate an ability for the vehicle to accommodate an accessory such as a wheelchair tub wherein the vehicle frame apparatus comprises:
an axle, said axle having a first end and a second end, said axle extending across a rear portion of the vehicle;
a hanger assembly, said hanger assembly being present on both a left rear side of the vehicle and a right rear side of the vehicle, said hanger assembly operably coupled to a portion of a chassis of the vehicle, said hanger assembly configured to provide a mounting position of the axle that is lower than that of a mounting position of the axle in the vehicle without said hanger assembly;
a spring mount assembly, said spring mount assembly configured to secure a spring of an independent suspension, said spring mount assembly being operably coupled to said hanger assembly, said spring mount assembly having an upper portion and a lower portion; and
wherein the hanger assembly further includes at least one support arm anchoring the hanger assembly to the chassis of the vehicle.

2. The vehicle frame apparatus as recited in claim 1, wherein said hanger assembly further includes an upper support member, said upper support member being planar in manner, said upper support member having an upper section that is curved in shape, said upper section being secured to the chassis of the vehicle.

3. The vehicle frame apparatus as recited in claim 2, wherein said hanger assembly further includes a lower portion, said lower portion being operably coupled to said upper support member, said lower portion extending downward from the chassis.

4. The vehicle frame apparatus as recited in claim 3, wherein said lower portion of said spring mount assembly includes a first portion, said first portion of said lower portion of said spring mount assembly being annular in shape, said lower portion of said spring mount assembly having an upper surface.

5. The vehicle frame apparatus as recited in claim 4, wherein said upper surface of said lower portion of said first portion of said spring mount assembly has a spring engagement member formed thereon, said spring engagement member extending upward from said upper surface.

6. The vehicle frame apparatus as recited in claim 5, wherein said spring mount assembly further includes a spring retention member, said spring retention member being adjacent said first portion of lower portion of said spring mount assembly and perpendicular thereto.

7. The vehicle frame apparatus as recited in claim 6, and further including a first hub spacer and a second hub spacer, said first hub spacer being secured to a hub mount at said first end of said axle, said second hub spacer being secured to said second end of said axle to a hub mount.

8. The vehicle frame apparatus as recited in claim 7, wherein said hanger assembly includes a rear support arm member, said rear support arm member being secured to a rear side of the hanger assembly and the chassis of the vehicle.

9. A vehicle frame apparatus that is mounted to a vehicle so as to position an axle in a second position wherein the second position is more distal to a chassis than a first position in order to accommodate a wheelchair tub wherein the vehicle frame apparatus:
an axle, said axle having a first end and a second end, said axle extending across a rear portion of the vehicle, said axle having a hub mount proximate said first end, said axle having a second hub mount proximate said second end;
a hanger assembly, said hanger assembly being present on both a left rear side of the vehicle and a right rear side of the vehicle, said hanger assembly having an upper support member, said upper support member having an upper section and a lower section, said upper section and said lower section being contiguously formed, said upper section of said upper support member being curved in shape and configured to be secured to a portion of a chassis of the vehicle, said hanger assembly further having a lower support member, said lower support member extending downward from said chassis;
a spring mount assembly, said spring mount assembly configured to secure a spring of an independent suspension, said spring mount assembly having an upper spring mount member and a lower spring mount member, said upper spring mount member and said lower spring mount member configured to operably retain a spring therebetween, said spring mount assembly operably coupled to said lower support member of said hanger assembly via a suspension arm member; and
wherein the hanger assembly is operable to move the axle to the second position so as to lower the position thereof relative to the chassis.

10. The vehicle frame apparatus mounted to a vehicle so as to position an axle in a second position in order to allow the vehicle to accommodate a wheelchair tub as recited in claim 9, wherein said lower support member of said hanger assembly includes a upper portion and a lower portion, said upper portion having an upper end being secured to the chassis, said upper portion and said lower portion being contiguous.

11. The vehicle frame apparatus mounted to a vehicle so as to position an axle in a second position in order to allow the vehicle to accommodate a wheelchair tub as recited in claim 10, wherein said lower portion further includes a void, said void having an opening providing access thereto, said void of said lower portion configured to be operably coupled to an end of the suspension arm member.

12. The vehicle frame apparatus mounted to a vehicle so as to position an axle in a second position in order to allow the vehicle to accommodate a wheelchair tub as recited in claim 11, wherein said upper spring mount is secured to an inner surface of a wheel well of the vehicle, said upper spring mount being conical in shape, said upper spring mount extending downward from the wheel well.

13. The vehicle frame apparatus mounted to a vehicle so as to position an axle in a second position in order to allow the vehicle to accommodate a wheelchair tub as recited in claim 12, wherein the lower spring mount member includes a first portion, said first portion being annular in shape, said first portion having an upper surface, said upper surface having a spring engagement member extending upward therefrom configured to operably engage a lower end of the spring.

14. The vehicle frame apparatus mounted to a vehicle so as to position an axle in a second position in order to allow the vehicle to accommodate a wheelchair tub as recited in claim 13, wherein said lower spring mount member further includes a spring retention member, said spring retention member being adjacent said first portion of the lower spring mount member, said spring retention member having a portion thereof that is C-shaped.

15. The vehicle frame apparatus mounted to a vehicle so as to position an axle in a second position in order to allow the vehicle to accommodate a wheelchair tub as recited in claim 14, and further including a first hub spacer and a second hub spacer, said first hub spacer and said second hub spacer configured to move a hub secured thereto outwards from the first end and second end of the axle.

16. The vehicle frame apparatus mounted to a vehicle so as to position an axle in a second position in order to allow the vehicle to accommodate a wheelchair tub as recited in claim 15, wherein said lower support member of said hanger assembly further includes a first support arm member, said first support arm member being secured to said upper portion of said lower support member and the chassis.

17. The vehicle frame apparatus mounted to a vehicle so as to position an axle in a second position in order to allow the vehicle to accommodate a wheelchair tub as recited in claim 16, wherein said lower support member of said hanger assembly further includes a second support arm member, said second support arm member being operably coupled to said lower portion of said lower support member and the chassis.
